(19) United States
(12) Patent Application Publication
(10) Pub. No.: US 2004/0047645 A1
(43) Pub. Date: Mar. 11, 2004

(54) Wet type electrophotographic image forming device with oxidation catalyst filter

(75) Inventors: Young-Ha No, Seongnam-city (KR); Kwang-Ho No, Suwon-city (KR); Kyong-Yol Yon, Seongnam-city (KR); Jeong-Hun Pang, Suwon-city (KR); Joong-Hwan Choi, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/617,830

(22) Filed: Jul. 14, 2003

(30) Foreign Application Priority Data
Sep. 10, 2002 (KR) 2002-54543

(51) Int. Cl. G03G 21/20

(52) U.S. Cl. 399/93

(57) ABSTRACT

A wet type electrophotographic printer having a catalyst oxidation filter therein includes a discharge passage to discharge air inside of a printer body to the outside, a blower in the discharge passage to guide the air inside of the printer body, and a catalyst oxidation filter arranged in the discharge passage. The catalyst oxidation filter includes a matrix coated with an oxidation catalyst, to deodorize the air which is guided to the discharge passage as the air is passed therethrough.

### CROSS-REFERENCE TO RELATED APPLICATIONS

This application claims the benefit of Korean Application No. 2002-54543, filed Sep. 10, 2002, in the Korean Intellectual Property Office, the disclosure of which is incorporated herein by reference.

### BACKGROUND OF THE INVENTION

1. Field of the Invention

The present invention generally relates to a wet-type electrophotographic image forming device, and more particularly, to a wet-type electrophotographic image forming device with an oxidation catalyst filter having a metallic honeycomb structure matrix or heating mat that accelerates the increase in temperature of the oxidation catalyst filter and thus effectively filters and passes air inside the body of the device.

2. Description of the Related Art

Generally, an electrophotographic image forming device such as a printer may be categorized into either a dry type that uses a powder toner, or a wet type that uses liquid toner where toner particles are dispersed in carrier liquid such as NORPAR. Both the dry type and wet type are used in the printing process in which an electrostatic latent image is formed on a photoreceptor medium such as a photoreceptor drum, the toner is fed onto the electrostatic latent image to thereby develop into a visible image, and the developed image is printed onto a printing paper passing between the photoreceptor body and a transfer medium that is rotated in contact with the photoreceptor body.

While the dry type electrophotographic printer has some disadvantages such as harmful toner powders, the wet type electrophotographic printer generates no harmful toner powders and provides excellent printing quality. Accordingly, the wet type electrophotographic printer is in growing demand.

FIG. 1 is a schematic view showing the structure of a conventional wet type electrophotographic printer. As shown, the wet type electrophotographic printer includes a body 80, a fusing roller 40, organic photoreceptors 50a-50d, developing rollers 51a-51d, laser scanning units 60a-60d, and an intermediate transfer belt 70.

The carrier liquid of the wet type electrophotographic printer includes a pigment, a binder resin and a charge director dispersed therein. For developing an image on the printing medium, such as a paper, in the wet type electrophotographic printer, first, an electrostatic latent image is formed on the organic photoreceptors 50a-50d by the laser beams emitted from the laser scanning units 60a-60d. Then, the carrier liquid is attached to the electrostatic latent image of the organic photoreceptors 50a-50d by the developing rollers 51a-51d. Next, the developed image is transferred to the printing medium, and as the printing medium and the image thereon are passed through the heated fusing roller 40, the carrier liquid dissipates in vapor. Mainly, there is a hydrocarbon mixture in the carrier liquid and vapor thereof. The hydrocarbon mixture is usually one of volatile organic compounds (VOCs) such as benzene, acetylene, gasoline, toluene, ethylene, phenol, methanol, butanol, acetone, methylethyl ketone, and acetic acid. Through a photochemical reaction with the nitrogen oxide, the VOCs generate photochemical oxide, causing photochemical smog. The VOCs are poisonous chemical substances that pollute the air and may cause cancer, and is the precursor of the photochemical oxide.

Due to the problems such as foul smell and environmental pollution, the use of the wet type electrophotographic printer has been limited despite the advantages over the dry type electrophotographic printer.

Many researches have been performed on the filtering method that could overcome the problems of the carrier liquid of the wet type electrophotographic printer. One such method is to use a carbon filter such as activated charcoal. However, the inability of the carbon filter to decompose the carrier collected therein requires a replacement carbon filter when it reaches maximum capacity.

Korean Patent No. 10-0322558 and Japanese Patent Publication No. 3-067277 disclose a carrier filtering device for use in an electrophotographic printer. According to these references, the wet type electrophotographic printer or copier that employs a platinum catalyst filter has a catalyst matrix coated with ceramics. When the ceramic-coated matrix is used in the platinum catalyst filter, the operation of the printer usually starts before the platinum catalyst filter is heated to a predetermined temperature for activation. Accordingly, evaporation of the carrier liquid occurs on the fusing roller, hindering the platinum catalyst filter from functioning normally. As a result, it was very inefficient to use the platinum catalyst filter. Also, another drawback is that a heater is required to facilitate activation of the catalyst.

### SUMMARY OF THE INVENTION

Accordingly, it is an aspect of the present invention to provide a wet type electrophotographic printer having an oxidation catalyst filter which is capable of fast heating and also filtering out volatile organic compounds (VOCs) from the vapors of the carrier liquid evaporating in the printer and performing deodorization by using a metallic honeycomb structure matrix or heating mat.

Additional aspects and advantages of the invention will be set forth in part in the description which follows and, in part, will be obvious from the description, or may be learned by practice of the invention.

The foregoing and/or other aspects are accomplished by a wet type electrophotographic image forming device including a printer body; a discharge passage to discharge air inside of the printer body to an outside; a blower arranged in the discharge passage, to guide the air inside of the discharge passage; and a catalyst oxidation filter arranged in the discharge passage, and including a matrix coated with an oxidation catalyst, to deodorize the air which is guided through the discharge passage.

The oxidation catalyst includes at least one metal selected from the group consisting of Pt, Pd, Ru, Cu, Cr, Ce, Mn, Fe, Ni, Sn, Zn, Al, Zr, W, and V. Specifically, this metal may be selected from the group consisting of Pt, Pd and Ru.

The catalyst oxidation filter may be provided with a heater to transmit heat to the oxidation catalyst-coated matrix thereof.

If the heater is provided, the oxidation catalyst-coated matrix may be in a metallic honeycomb structure, or a honeycomb structured matrix including one compound selected from the group consisting of γ-Al₂O₃, TiO₂, ZrO₂, SiO₂, and SiO₂—Al₂O₃.

If the oxidation catalyst-coated matrix is in a metallic honeycomb structure, or a honeycomb structured matrix including one compound selected from the group consisting of γ-Al₂O₃, TiO₂, ZrO₂, SiO₂, and SiO₂—Al₂O₃, the heater surrounds an outer surface of the oxidation catalyst-coated matrix in close contact thereto. Further, the heater may be formed to have an identical shape to that of the oxidation catalyst-coated matrix in cross section, and is inserted in the oxidation catalyst-coated matrix, or formed to have an identical shape to that of the oxidation catalyst-coated matrix in cross section, and is arranged at either a front or a back of the oxidation catalyst-coated matrix.

For example, the shape in cross section of the honeycomb matrix and the heater may be a cylinder, a hexahedron, or the like. Furthermore, the oxidation catalyst-coated matrix may be a heating mat including a metallic heating element.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a schematic view showing a conventional wet type electrophotographic printer;

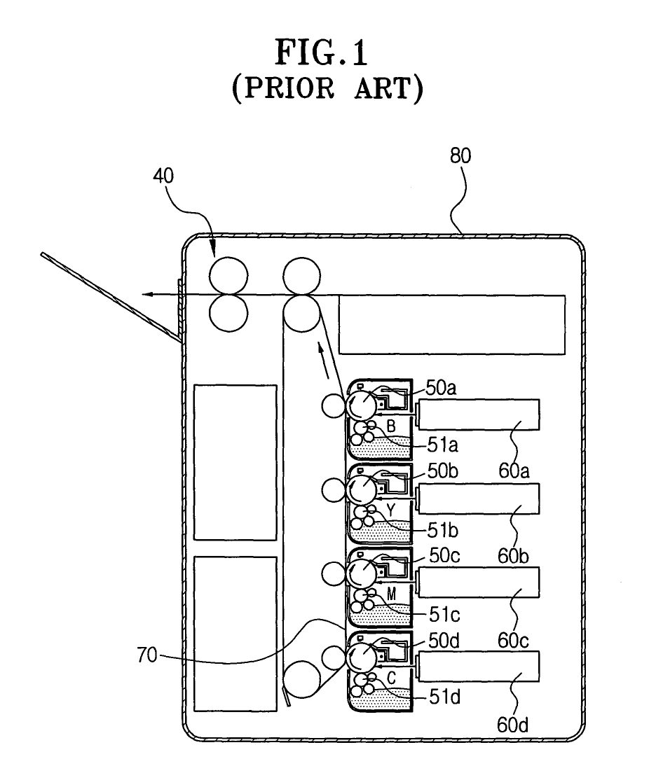

FIG. 2 is a schematic view showing a wet type electrophotographic image forming device having an oxidation catalyst filter according to an embodiment of the present invention;

FIGS. 3A to 3C are partial views schematically showing an oxidation catalyst filter for the wet type electrophotographic image forming device of FIG. 2 according to an aspect of the present invention; and

FIG. 4 is a partial view schematically showing an oxidation catalyst filter for the wet type electrophotographic image forming device of FIG. 2 according to another aspect of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

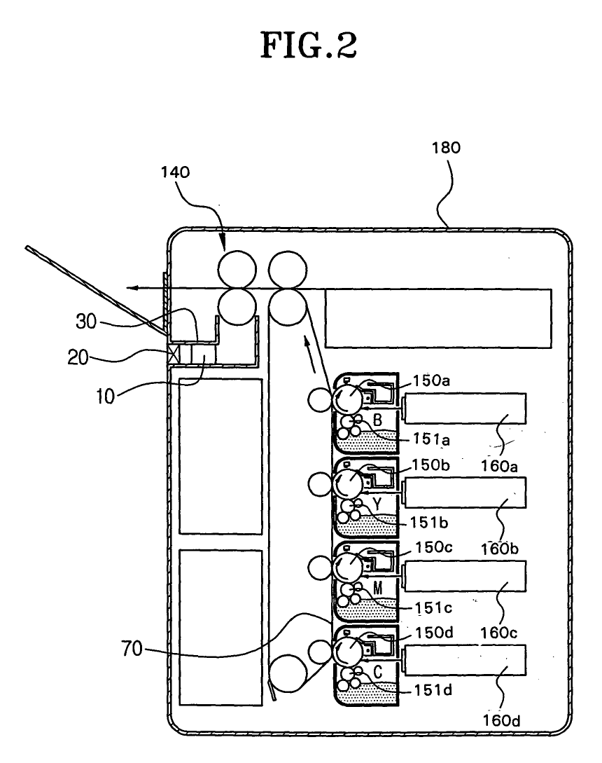

Referring to FIG. 2, a wet type electrophotographic image forming device, i.e., a printer according to an embodiment of the present invention includes features similar to those of the conventional wet type electrophotographic printer, namely a fusing roller 140, organic photoreceptors 150a-150d, developing rollers 151a-151d, laser scanning units 160a-160d, an intermediate transfer belt 170 and a body 180. The printer of the present embodiment further includes a discharge passage 30 provided near the fusing roller 140 to guide air inside the body 180 in a predetermined direction, a catalyst oxidation filter 10 disposed inside the discharge passage 30, and a fan 20.

As for the fusing roller 140, the organic photoreceptors 150a-150d, the developing rollers 151a-151d, the laser scanning units 160a-160d and the intermediate transfer belt 170, generally-known types of these elements may be used.

An air inlet of the discharge passage 30 is in the proximity of the fusing roller 140, and guides the air inside the body 180 in a predetermined direction, from the fusing roller 140 to the outside of the body 180. The direction of externally discharging the inside air through the discharge passage 30 may vary depending on the components being employed, and it may be the upper, lower, right, or left side of the fusing roller 40.

The oxidation catalyst filter 10 includes a matrix coated with an oxidation catalytic agent. The oxidation catalytic agent includes at least one metal selected from Pt, Pd, Ru, Cu, Cr, Ce, Mn, Fe, Ni, Sn, Zn, Al, Zr, W, V, for example, at least one metal from Pt, Pd, Ru.

The deodorization mechanism of the oxidation catalyst will now be described. For the purpose of deodorization, conventionally, aromatics having a strong scent were used to mask foul odors, or a deodorization substance was physically attached to the surface of the object to be deodorized. Chemicals were also used for the deodorization. When using the chemicals, neutralization and oxidation that involve chemicals, or oxidizing disintegration that calcines the malodorous substance were used.

For the calcination process, direct calcination and catalyst oxidation are usually used. The direct calcination burns up the malodorous substance at a high temperature, i.e., above the ignition temperature ranging from about 600° C. to about 800° C., while the catalyst oxidation burns up or thermally decomposes the malodorous substance in the gas containing oxygen in the relatively lower temperature, i.e., from about 150° C. to about 400° C., through the use of a catalyst.

The catalyst oxidation lowers the activation energy required for the catalyst to oxidizing-disintegrate the malodorous substance, and enables complete disintegration of the malodorous substance through the calcination in the relatively lower temperature range. The carrier mainly used in the wet type electrophotographic printer is a hydrocarbon mixture, and in order to lower the activation energy used for the oxidizing disintegration of the hydrocarbon mixture, the embodiment of the present invention employs a catalyst oxidation.

The catalyst is not directly involved in the reaction, but speeds the reaction. One example of the basic reaction formula with respect to the combustible hydrocarbon (CₘH₂ₙ) is as follows:

CₘH₂ₙ+(m+n/2)O₂→mCO₂+nH₂O+calorie Reaction formula 1

Wherein m and n are integers greater than zero.

The result of the catalyst oxidation reaction heavily depends on the type and lifespan of the catalyst. Oxidation activity with respect to methane varies by the following order depending on the type of catalyst:

Pd>Pt>Co₃O₄>PdO>Cr₂O₃>Mn₂O₃>CuO>SeO₂>FeO₂>Fe₂O₃>V₂O₅>NiO>Ag>MoO₃>TiO₂> . . . .

The palladium is unstable and has low durability against catalyst poison, and cobalt oxide and manganese oxide tend to be inactive at a high temperature. Accordingly, a catalyst dipped in platinum is usually used for the catalyst oxidation, because platinum has high activity and heat resistance, and poisoning resistance.

A honeycomb structure matrix, or heating mat, may be used as the catalyst body. The honeycomb matrix can be made either of a metal, or a compound selected from γ-Al₂O₃, TiO₂, ZrO₂, SiO₂, and SiO₂—Al₂O₃. A heater is provided if the honeycomb structure having the catalyst body coated with the oxidation catalyst is used.

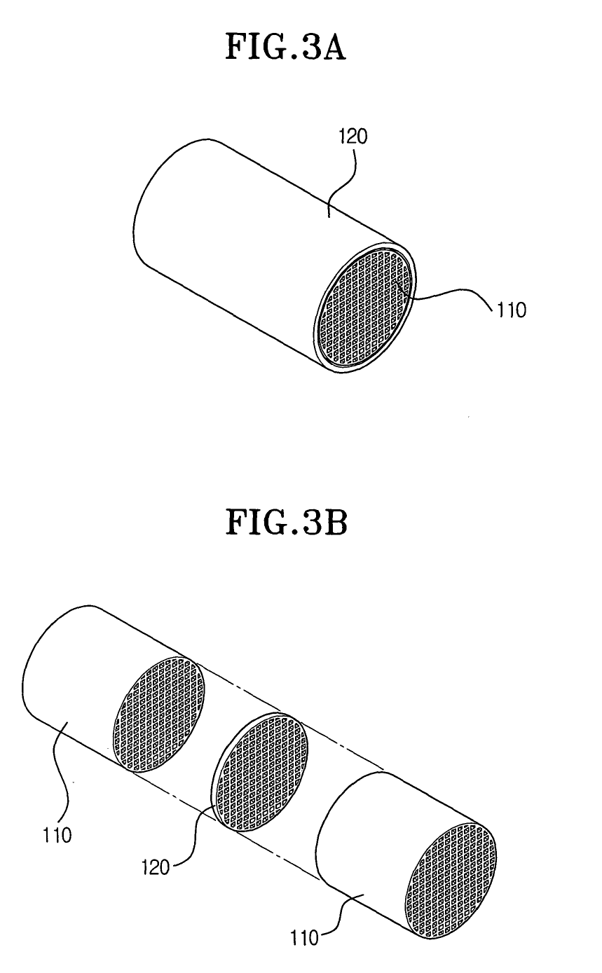

Referring to FIGS. 3A to 3C, a honeycomb matrix 110 coated with the oxidation catalyst is in a checkered pattern having a plurality of holes formed therein. The more densely perforated honeycomb matrix 110 has a larger surface area coated with the oxidation catalyst, and thus can be involved in the catalyst oxidation of the carrier vapor more actively. Accordingly, it is better for the filtering to use a more densely perforated honeycomb matrix 110.

The catalyst oxidation filter may include the honeycomb matrix 110 and a heater 120 surrounding the honeycomb matrix 110 (see FIG. 3A). Also, the catalyst oxidation filter may include the honeycomb matrix 110, and a heater having the same shape as the honeycomb matrix 110 in cross section to be inserted in the middle of the honeycomb matrix 110 (see FIG. 3B). Also, the catalyst oxidation filter may include the honeycomb matrix 110, and two of the heaters 120 having a same shape as the honeycomb matrix 110 in cross section being arranged at the front or back of the honeycomb matrix 110 (see FIG. 3C). As an example, the honeycomb matrix 110 and the heater 120 may both have a shape of a cylinder or a hexahedron in cross section.

Although the catalyst oxidation filter 10 is depicted as a cylinder in FIGS. 3A to 3C, the shape of the catalyst oxidation filter 10 may vary depending on the structure of the discharge passage 30. Accordingly, the catalyst oxidation filter 10 may be formed as a hexahedron. The length of the catalyst oxidation filter 10 may also vary.

In the case of using Pt, or Pd as a catalyst, the heater 120 must heat the matrix 110 being coated with the catalyst to about 200° C., the optimum temperature for the activation of the catalyst. While the ceramic-coated honeycomb matrix 110 takes a considerable amount of time to be heated to the proper temperature, a metallic honeycomb matrix, or a honeycomb matrix coated with the compound selected from γ-Al₂O₃, TiO₂, ZrO₂, SiO₂, SiO₂—Al₂O₃ is rapidly heated, and thus can deodorize through the complete oxidizing-disintegration of the carrier liquid immediately after the power supply to the printer.

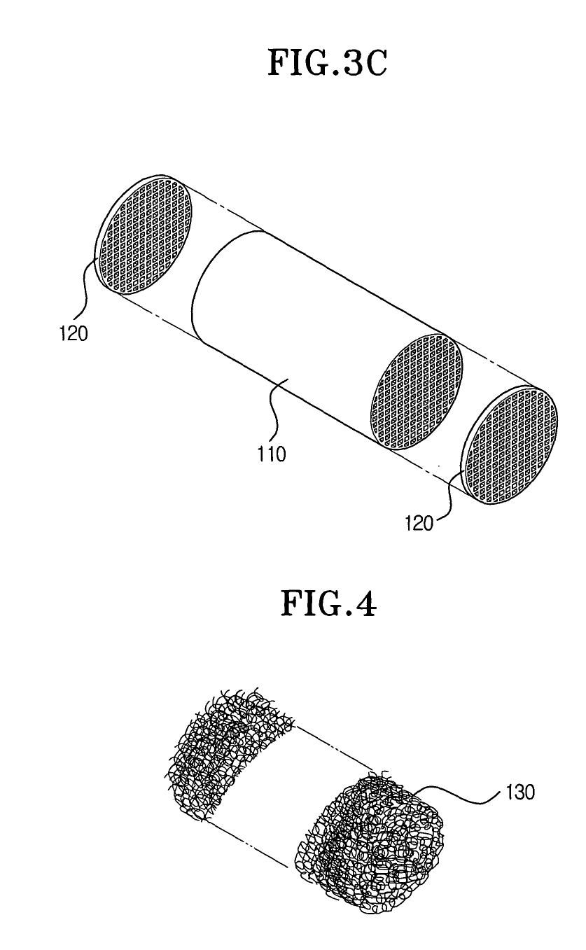

Referring to FIG. 4, the oxidation catalyst filter 10 includes a heating mat 130, i.e., a metallic heating element coated with the oxidation catalyst. In the case of using the heating mat 130 coated with the oxidation catalyst as the catalyst oxidation filter 10, there is no need to employ the heater 120. The heating mat 130 may be a non-woven fabric or sponge, which is obtained by networking a yarn in 3-dimensions and compressing it by pressing. Since the metallic heating element is formed in a non-woven fabric structure, the heating mat 130 has a large surface area. Also, being a metallic heating element, the heating mat 130 is rapidly heated, and actively involved in the oxidation of the catalyst. Accordingly, the heating mat 130 can decompose the carrier immediately after the printer starts the operation.

The vapor of the carrier is decomposed into carbon dioxide and water vapor by the catalyst oxidation filter 10 through the reaction represented by the above Reaction Formula 1. The decomposed carbon dioxide and water vapor are discharged outside of the printer, while the oxidation catalyst returns to the initial state after the reaction. Accordingly, the catalyst oxidation filter needs no replacement, and thus can be used for a long time.

In order to guide the air towards the predetermined direction, the fan 20 is provided inside of the discharge passage 30. The fan 20 may be provided between the inlet portion of the discharge passage 30 and the catalyst oxidation filter 10, or between the catalyst oxidation filter 10 and the outlet portion of the discharge passage 30. Two or more of the fans 20 may be provided.

In the wet type electrophotographic printer having the catalyst oxidation filter 10 according to the embodiment of the present invention, while the printing medium such as paper is passed through the heated fusing roller 140, the carrier is evaporated, generating a harmful vapor of a hydrocarbon composition. However, the harmful vapor of the hydrocarbon composition is decomposed into carbon dioxide and water vapor by the catalyst oxidation while it is drawn into the discharge passage 30 and passed through the catalyst oxidation filter 10. Such decomposed carbon dioxide and water vapor are discharged outside of the printer through the outlet portion of the discharge passage 30. Accordingly, a wet type electrophotographic printer discharges odorless and nonpoisonous air.

As described above, with the wet type electrophotographic printer having a catalyst oxidation filter according to the embodiment of the present invention, the harmful VOCs generated inside of the printer body due to evaporation of the carrier are decomposed into carbon dioxide and water vapor and externally discharged. Accordingly, a wet type electrophotographic printer with high printing quality can be provided without generating environment pollution.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A wet type electrophotographic image forming device comprising:
a printer body;
a discharge passage to discharge air inside of the printer body to an outside;
a blower arranged in the discharge passage, to guide the air inside of the discharge passage; and
a catalyst oxidation filter arranged in the discharge passage, and comprising a matrix coated with an oxidation catalyst, to deodorize the air which is guided through the discharge passage.

2. The wet type electrophotographic image forming device of claim 1, wherein the oxidation catalyst comprises at least onemetal selected from the group consisting of Pt, Pd, Ru, Cu, Cr, Ce, Mn, Fe, Ni, Sn, Zn, Al, Zr, W, and V.

3. The wet type electrophotographic image forming device of claim 1, wherein the oxidation catalyst comprises at least onemetal selected from the group consisting of Pt, Pd and Ru.

4. The wet type electrophotographic image forming device of claim 1, wherein the catalyst oxidation filter further comprises a heater to transmit heat to the matrix.

5. The wet type electrophotographic image forming device of claim 4, wherein the matrix has a metallic honeycomb structure.

6. The wet type electrophotographic image forming device of claim 4, wherein the matrix has a honeycomb structure made of an element selected from the group consisting of γ-Al₂O₃, TiO₂, ZrO₂, SiO₂, SiO₂—Al₂O₃.

7. The wet type electrophotographic image forming device of claim 4, wherein the heater surrounds an outer surface of the matrix in contact thereto.

8. The wet type electrophotographic image forming device of claim 4, wherein the heater has an identical shape with a shape of the matrix in cross section, and is inserted in the matrix.

9. The wet type electrophotographic image forming device of claim 4, wherein the heater has an identical shape with a shape of the matrix in cross section, and is arranged at either a front or a back of the matrix.

10. The wet type electrophotographic image forming device of claim 1, wherein the matrix is a heating mat comprised of a metallic heating element.

11. A wet type electrophotographic image forming device comprising:
a body;
a discharge passage to discharge air inside of the body to an outside of the body;
a catalyst oxidation filter arranged in the discharge passage, and comprising a matrix coated with an oxidation catalyst, to deodorize the air which is in the discharge passage.

12. The wet type electrophotographic image forming device of claim 11, further comprising:
a blower arranged in the discharge passage, to guide the air inside of the discharge passage.

13. The wet type electrophotographic image forming device of claim 11, further comprising a fusing roller in a vicinity of the discharge passage to fuse an image onto a paper.

14. The wet type electrophotographic image forming device of claim 11, wherein the catalyst oxidation filter comprises a honeycomb structure.

15. The wet type electrophotographic image forming device of claim 11, wherein the catalyst oxidation filter comprises a heating mat.

16. The wet type electrophotographic image forming device of claim 14, further comprising a heater to surround the honeycomb structure.

17. The wet type electrophotographic image forming device of claim 16, wherein the oxidation catalyst and the heater each comprise a cylinder or a hexahedron in cross section.

18. The wet type electrophotographic image forming device of claim 14, wherein the honeycomb structure is made of a metal.

19. The wet type electrophotographic image forming device of claim 14, wherein the honeycomb structure is made of a compound selected from the group consisting of γ-Al₂O₃, TiO₂, ZrO₂, SiO₂, and SiO₂—Al₂O₃.

20. The wet type electrophotographic image forming device of claim 15, wherein the heating mat is a non-woven fabric or a sponge of metallic materials.

21. An apparatus comprising:
an image forming unit to form an image on a medium with a liquid toner comprising toner particles and a carrier;
a fusing unit to fuse the image on the medium and evaporate the carrier, thereby generating a hydrocarbon vapor; and
a catalyst oxidation filter to decompose the hydrocarbon vapor into carbon dioxide and water.
